(19) United States
(12) Patent Application Publication
(10) Pub. No.: US 2025/0292074 A1
(43) Pub. Date: Sep. 18, 2025

(54) AUGMENTING A LARGE LANGUAGE MODEL WITH AN EXTERNAL MODEL

(71) Applicant: INTERNATIONAL BUSINESS MACHINES CORPORATION, ARMONK, NY (US)

(72) Inventors: Zhong Fang Yuan, Xi'an (CN); Tong Liu, Xi'an (CN); Xiao Ye Li, BeiJing (CN); Si Tong Zhao, Beijing (CN)

(21) Appl. No.: 18/607,060

(22) Filed: Mar. 15, 2024

(51) Int. Cl. G06N 3/0499; G06N 3/045

(52) U.S. Cl. CPC G06N 3/0499; G06N 3/045

(57) ABSTRACT

A question is received at a first language machine learning model. In response to an external machine learning model providing a response to the question and a confidence determination for the response that exceeds a predetermined threshold, the response is injected into the first language machine learning model so that the response overwrites a vector state layer output of the first language machine learning model that provides another response to the question and without modifying original parameters of the first language machine learning model, where the external machine learning model was trained with training material with which the first language machine learning model was not trained.

### BACKGROUND

Embodiments relate to machine learning models, large language models, training machine learning models, and performing automated question-answering with machine learning models.

A large language model (LLM) is a language machine learning model notable for its ability to achieve general-purpose language generation and understanding. LLMs acquire such abilities by learning statistical relationships from text documents during a computationally intensive self-supervised and semi-supervised training process. LLMs may use artificial neural networks, some of which may be built via a transformer-based architecture.

In the transformer-based architecture, a transformer is a deep learning architecture based on a multi-head attention mechanism. Input text is split into n-grams encoded as tokens and each token is converted into a vector via a look up from a word embedding table. At each layer, each token is then contextualized within the scope of the context window with other unmasked tokens via a parallel multi-head attention mechanism allowing the signal for key tokens to be amplified and less important tokens to be attenuated.

Chat Generative Pre-trained Transformer (ChatGPT) is an example of a generative Al based chatbot that uses the transformer-based architecture. Based on a large language model, ChatGPT enables users to refine and steer a conversation towards a desired length, format, style, level of detail, and language. Successive prompts and replies, known as prompt engineering, are considered at each conversation stage as a context to provide answers to user queries.

### SUMMARY

Provided are a method, system, and computer program product in which a question is received at a first language machine learning model. In response to an external machine learning model providing a response to the question and a confidence determination for the response that exceeds a predetermined threshold, the response is injected into the first language machine learning model so that the response overwrites a vector state layer output of the first language machine learning model that provides another response to the question and without modifying original parameters of the first language machine learning model, where the external machine learning model was trained with training material with which the first language machine learning model was not trained.

### BRIEF DESCRIPTION OF THE DRAWINGS

Referring now to the drawings in which like reference numbers represent corresponding parts throughout:

FIG. 1 illustrates a block diagram of a computing environment, in accordance with certain embodiments.

FIG. 2 illustrates a block diagram of a transformer architecture that is augmented with an external model, in accordance with certain embodiments.

FIG. 3 illustrates a block diagram that shows a Feed-Forward Network (FFN) in the transformer architecture in accordance with certain embodiments.

FIG. 4 illustrates a block diagram that shows augmentation of a LLM with an external model, in accordance with certain embodiments.

FIG. 5 illustrates a block diagram that shows a first set of operations, in accordance with certain embodiments.

FIG. 6 illustrates a block diagram that shows a second set of operations, in accordance with certain embodiments.

FIG. 7 illustrates a block diagram that shows a third set of operations, in accordance with certain embodiments.

FIG. 8 illustrates a block diagram that shows operations to build an external knowledge injector, in accordance with certain embodiments.

FIG. 9 illustrates a block diagram that shows operations for determining when the output of an LLM should be overwritten with the output of the external model, in accordance with certain embodiments.

FIG. 10 illustrates certain exemplary operations to augment an LLM with an external model, in accordance with certain embodiments.

FIG. 11 illustrates certain additional exemplary operations to augment an LLM with an external model, in accordance with certain embodiments.

FIG. 12 illustrates a computing environment in accordance with certain embodiments.

### DETAILED DESCRIPTION

In the following description, reference is made to the accompanying drawings which form a part hereof and which illustrate several embodiments. It is understood that other embodiments may be utilized, and structural and operational changes may be made.

Recently, LLMs represented by applications like ChatGPT, and others have achieved excellent results in many tasks such as question answering, dialogue, and information retrieval. However, since all the data is offline data during training of such an application, the “memory” of such an application is “frozen” at the time the application is trained. For example, if a question was asked requesting the name of the current Prime Minister of a country, where the Prime Minister of the country had changed after the application was trained, an incorrect answer may be provided by the application.

In another example, a user may ask a question that the LLM has not been trained for. For example, a user may ask, “What is the capital of the country of Palapala?” where the country of Palapala is a fictional country that exists in a work of fiction which was not part of the training materials for an LLM. However, an LLM may output that the answer is “Asunción”, the capital of “Paraguay”, as “Paraguay” may appear close enough to the fictitious country of “Palapala” or the LLM may not provide an answer to the question. The examples provided above imply that there may be certain knowledge that has not been included in LLM training. Such knowledge may be about real-time events that happened recently, obscure knowledge in some specific industries, or something else.

From the above examples, it can be seen that if the user wants to query some real-time knowledge or previously unknown knowledge, the LLM in some circumstances cannot give an effective and correct answer. In the era of small models, the easiest way is to add real-time knowledge and then retrain the model, or to fine-tune the model after adding real-time knowledge, but this mechanism is invalid in the LLM era, because in the technical system of LLM, fine-tuning is a very expensive act, and retraining is also very expensive. In addition, fine-tuning may also cause the LLM to have the so-called “catastrophic forgetting problem”, that is, the LLM learns new knowledge and forgets old knowledge.

Certain embodiments of the present disclosure provide mechanisms to provide a solution when it is not cost effective to either retrain or fine-tune an existing LLM model, such that the LLM model can learn new knowledge. The mechanisms include augmenting an LLM model with an external model. As a result, in certain embodiments improvements are made to the operations of LLM models used in generative AI applications implemented in a computational device.

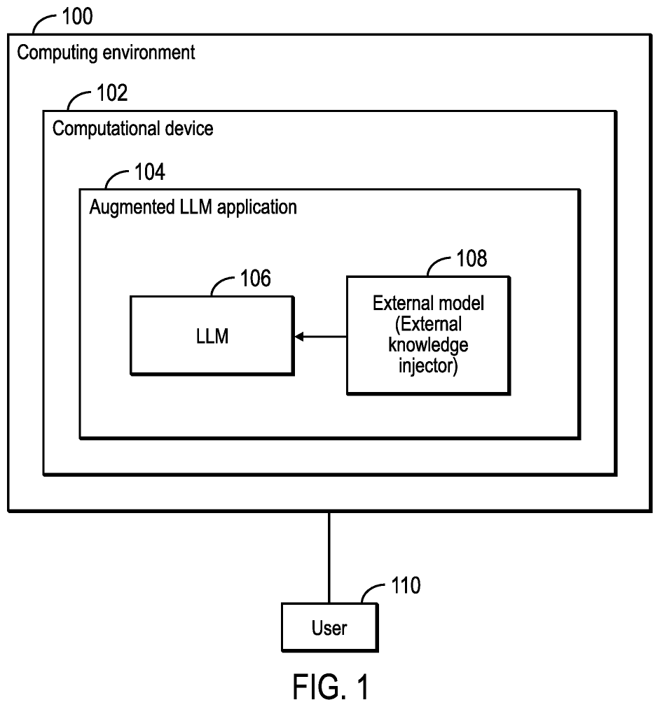

FIG. 1 illustrates a block diagram of a computing environment 100, in accordance with certain embodiments.

A computational device 102 includes an augmented LLM application 104, where the augmented LLM application 104 includes an LLM 106 and an external model 108. The external model 108 may also be referred to as an external knowledge injector as the external model 108 is injected into the LLM 106. The external model 108 includes additional information that is not found in the LLM 106. In certain embodiments, the augmented LLM application 104 is able to interact with a user 110 by using the LLM 106 to which the external model 108 has been injected.

In certain embodiments, modifying the original parameters of the LLM 106 to include the updated or additional information is relatively more time consuming in comparison to injecting the external model 108 to the LLM without modifying the original parameters of the LLM 106. In certain embodiments, the external model 108 is smaller in size than the LLM. This size comparison refers to the external model 108 having fewer layers and/or fewer parameters than the LLM 106 has. In certain embodiments, no retraining or fine-tuning of the LLM model is performed to accompany the injection.

In certain embodiments, the computational device 102 may comprise any suitable computational device known in the art such as a mainframe, a personal computer, a laptop, a telephony device, etc. The computational device 102 may be coupled to any suitable network that includes the Internet, a wide area network, an intranet, etc., where the user 112 may communicate with the computational device 102 over the network.

In certain embodiments, the augmented LLM application 104 may be implemented in hardware, software, firmware, or any combination thereof.

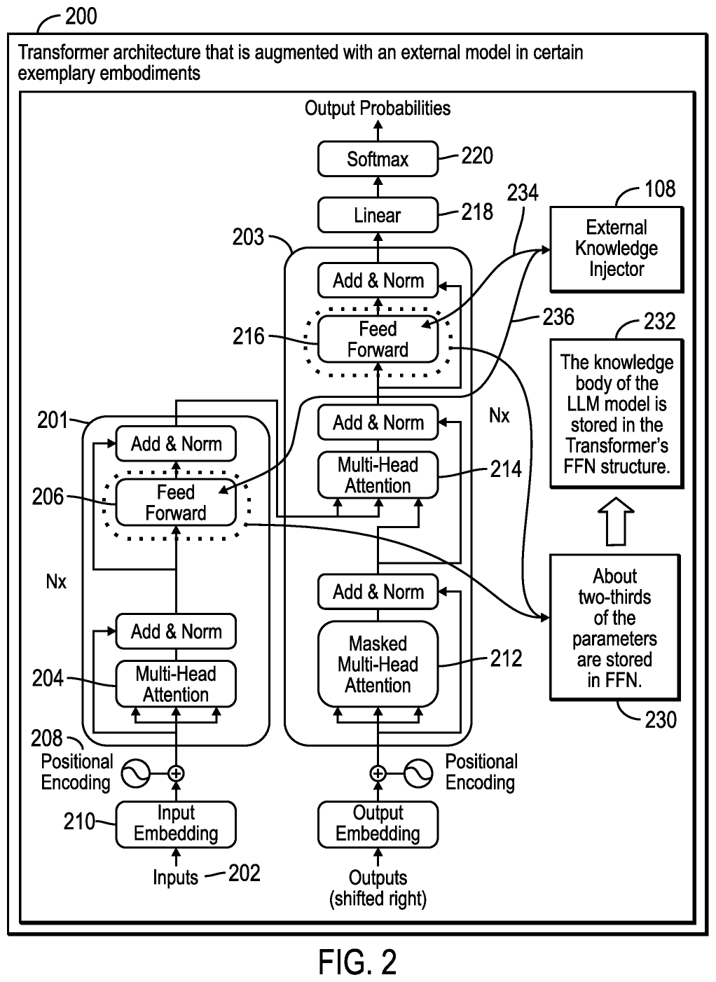

FIG. 2 illustrates a block diagram of a transformer architecture 200 of an LLM 106 that may be augmented by the external model 108, in accordance with certain embodiments.

The transformer architecture shown in FIG. 2 follows an encoder-decoder structure but does not rely on recurrence and convolutions in order to generate an output. The task of the encoder 201, on the left half of the transformer architecture, is to map an input sequence (shown via reference numeral 202) to a sequence of continuous representations, which is then fed into a decoder 203 that is shown on the right half of the transformer architecture. The decoder 203 receives the output of the encoder 201 together with the decoder output at the previous time step to generate an output sequence. At each step, the model is auto-regressive, consuming the previously generated symbols as additional input when generating the next.

The encoder 201 comprises a stack of a plurality of identical layers, where each layer is comprised of two sublayers: The first sublayer implements a multi-head attention mechanism (shown via reference numeral 204). The multi-head attention mechanism implements heads that receive a different linearly projected version of the queries, keys, and values, each to produce outputs in parallel that are then used to generate a final result.

The second sublayer of the encoder 201 is a fully connected feed-forward network 206 comprised of two linear transformations with Rectified Linear Unit (RELU) activation in between.

The plurality of layers of the encoder 201 apply the same linear transformations to all the words in the input sequence, but each layer employs different weight and bias parameters to do so. It may be noted that the transformer architecture cannot inherently capture any information about the relative positions of the words in the sequence since it does not make use of recurrence. This information has to be injected by introducing positional encodings 208 to the input embeddings 210. To generate the input embeddings 210, input text as an input sequence 202 is split into n-grams encoded as tokens and each token is converted into a vector via an automated look up from a word embedding table stored in computer memory.

The vectors of the positional encodings 208 are of the same dimension as the input embeddings 210 and are generated using sine and cosine functions of different frequencies. Then, they are summed to the input embeddings 210 in order to inject the positional information.

The decoder 203 shares several similarities with the encoder 201. The decoder 203 also comprises a stack of a plurality of identical layers that are each composed of three sublayers: The first sublayer receives the previous output of the decoder stack (shown at the bottom of FIG. 2 as Outputs (shifted right)), augments it with positional information, and implements a masked multi-head attention 212 mechanism over it. The Outputs (shifted right) refers to output that exits from the decoder 203 as being reintroduced at the beginning of the decoder 203, but with an output token added to the token sequence. The output token becomes the first token, the previous first token becomes the second token, and so forth. This shifting is the basis of the shifted right reference. The second sublayer implements a multi-head attention 214 mechanism similar to the one implemented in the first sublayer of the encoder 201. On the decoder side, this multi-head mechanism 214 receives the queries from the previous decoder sublayer and the keys and values from the output of the encoder 201. This allows the decoder 203 to attend to all the words in the input sequence. The third layer implements a fully connected feed-forward network 216, similar to the one implemented in the second sublayer of the encoder 201. Furthermore, the three sublayers on the decoder side also have residual connections around them and are succeeded by a normalization layer. Positional encodings are also added to the input embeddings of the decoder 203 as for the encoder 201.

In the transformer architecture each word that is part of an input sequence is transformed into a multi-dimensional embedding vector. Each embedding vector representing an input word is augmented by summing it (elementwise) to a positional encoding vector of the same length, hence introducing positional information into the input. The augmented embedding vectors are fed into the encoder block comprised of the two sublayers explained above. The decoder 203 receives as input its own predicted output word at time-step. The input to the decoder 203 is also augmented by positional encoding in the same manner as performed on the encoder side.

The augmented decoder input is fed into the three sublayers comprising the decoder block explained above. Masking is applied in the first sublayer in order to stop the decoder 203 from attending to the succeeding words. At the second sublayer, the decoder also receives the output of the encoder, which now allows the decoder 203 to attend to all the words in the input sequence. The output of the decoder 203 finally passes through a fully connected layer 218 (shown in FIG. 2 as “Linear”), followed by a softmax layer 220, to generate a prediction for the next word of the output sequence.

FIG. 2 describes certain mechanisms that show how and where knowledge is stored in the LLM 106. LLM 106 uses massive data for training, and contains a large amount of knowledge in the hidden layer, which is stored in the parameters of the transformer architecture 200 shown in FIG. 2.

In the structure of the transformer architecture, the model parameters are incorporated into two parts: the multi-head attention (MHA) part (shown via reference numerals 204 and 214 at different instants of time in control flow) accounts for about one-third of the total parameters, and two-thirds of the parameters are concentrated in the feed forward network (FFN) structure (shown via reference numerals 206, 216 at different instants of time in control flow and via reference numeral 230).

MHA 204, 214 is mainly used to calculate the correlation strength between words or knowledge, and integrate the global information. MHA 204, 214 is more likely to establish the connection between knowledge. There is a high probability that no specific knowledge points are stored, so it may be inferred that the knowledge subject of the LLM 106 is stored in the transformer's FFN structure (as indicated via reference numeral 232).

It may be noted that there may be an encoder only, a decoder only, or a hybrid encoder-decoder architecture for language transformers. FIG. 2 shows a hybrid encoder-decoder architecture. In the hybrid encoder-decoder architecture shown in FIG. 2, the knowledge injection is performed at either the encoder 201 or the decoder 203 or at both the encoder 201 and the decoder 203. The knowledge injection may be via interactions between the external knowledge injector 108 with the feed forward networks (FFN) 206, 216 as the knowledge body is stored in the FFNs (the knowledge injection and interactions are shown via the arcs with reference numerals 234, 236).

In alternative embodiments, there may be a decoder-based architecture as is the case in the Generative Pre-trained Transformer (GPT) family. In such embodiments, the knowledge injection is to the decoder.

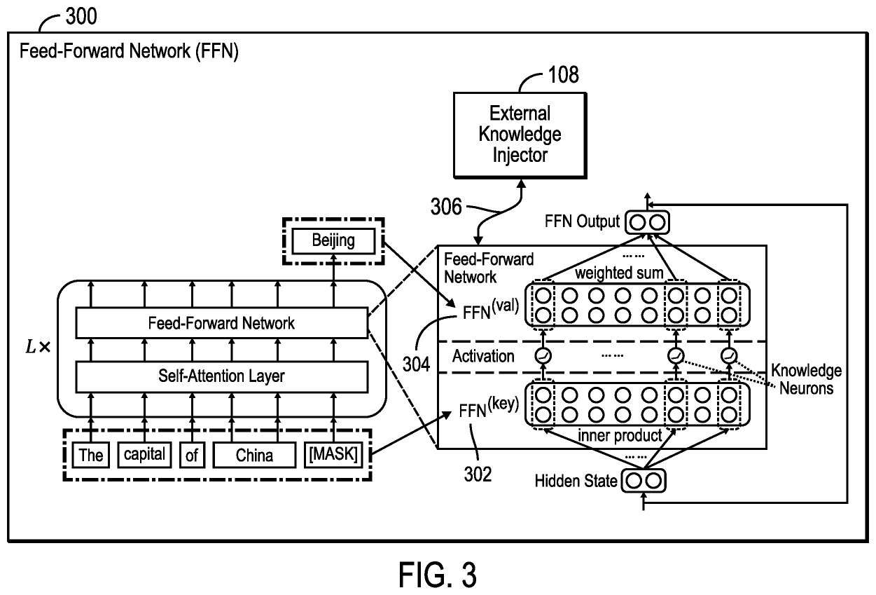

FIG. 3 illustrates a block diagram 300 that shows a Feed-Forward Network (FFN) 300 in accordance with certain embodiments.

Certain embodiments regard the transformer model's FFN as a Key-Value memory that stores a large amount of specific knowledge. The first layer of FFN is a hidden layer, which is the Key layer 302; the second layer is a narrow hidden layer, which is the Value layer 304. The input layer of FFN is actually the output result embedding of MHA corresponding to a certain word, that is, the embedding that integrates the input context related to the entire sentence through self-attention layer representing the overall information of the entire input sentence. Each neuron node in the Key layer records a pair of <Key, Value> information.

In certain embodiments, one node in FIG. 3 is the Key-Value memory that records the knowledge of <Beijing, is-capital-of, China>, and its Key vector is used to detect the knowledge pattern of “The capital of China is . . . ”. Its Value Vector basically stores a vector close to the Embedding of the word “Beijing”. When transformer's input is “the capital of China is [Mask]”, the node detects this knowledge pattern from the input layer, so it generates a larger response output. It is assumed that other neurons in the key layer do not respond to this input, and the corresponding nodes in the value layer will receive the word embedding corresponding to the Value of “Beijing”, and further numerical amplification is performed through the RELU function. Therefore, the output corresponding to the Mask position will naturally output the word “Beijing”.

In certain embodiments, the external knowledge injector 108 interacts with the FFN to inject knowledge as shown via the arc indicated via reference numeral 306.

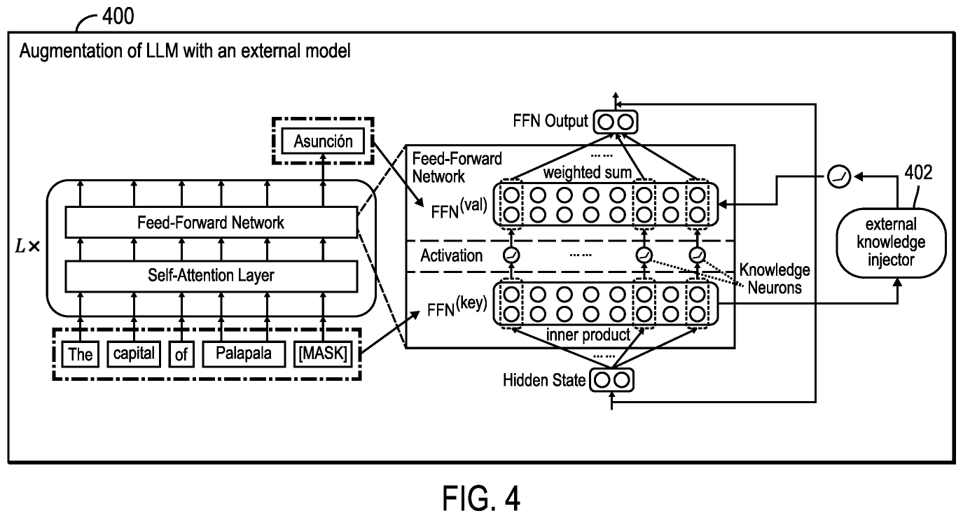

FIG. 4 illustrates a block diagram 400 that shows augmentation of LLM with an external model (i.e., external knowledge injector 402) in accordance with certain embodiments.

FIG. 4 shows that certain embodiments connect a knowledge base in the form of a model (external knowledge injector 402) between the first layer and the second layer of FFN. This knowledge base will store real-time knowledge that the LLM is not familiar with. During reasoning, the external knowledge base machine learning model will automatically check the problem itself. If it finds that its own knowledge is more real-time than the knowledge in the LLM, the external knowledge base machine learning model will generate a vector, which will replace the Value vector generated by the LLM FFN layer to achieve the purpose of rewriting the Value vector and updating the output. If the model knowledge base does not contain problem-related knowledge, the Value vector generated by the LLM FFN layer will not be replaced, and the final output is still consistent with the original output of the LLM.

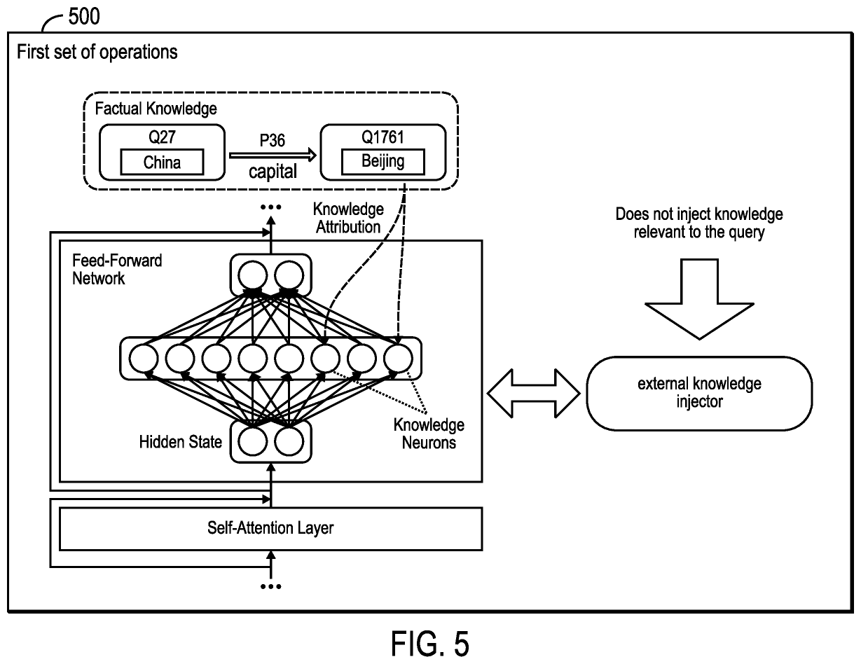

FIG. 5 illustrates a block diagram 500 that shows a first set of operations, in accordance with certain embodiments.

As shown in FIG. 5, when the question asks what the capital of China is, the external knowledge injector does not make any changes to the reply of LLM because the LLM does contain this knowledge.

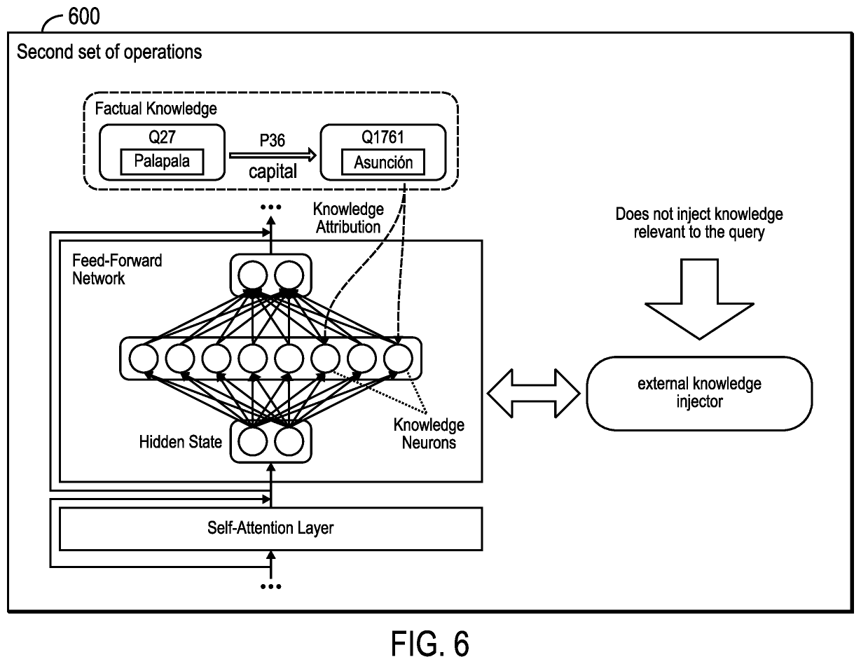

FIG. 6 illustrates a block diagram 600 that shows a second set of operations, in accordance with certain embodiments.

As shown in FIG. 6, when the question asks what the capital of the country of Palapala is, then the LLM answers Asunción as the capital of Paraguay as the external knowledge injection does not inject knowledge relevant to the query. This scenario occurs in some instances when the illustrated external knowledge injector is not trained with training materials that indicated what the capital city of the country Palapala is.

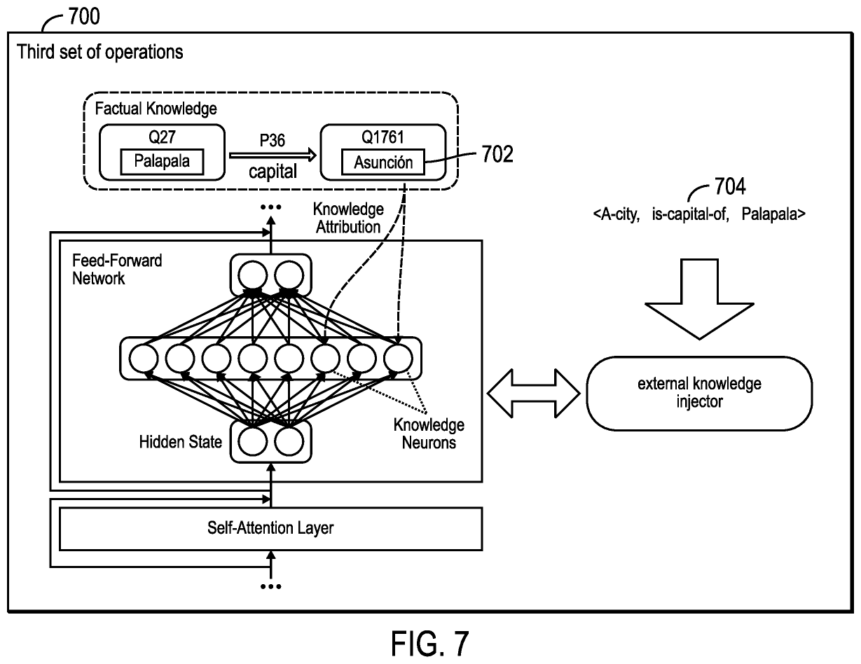

FIG. 7 illustrates a block diagram 700 that shows a third set of operations, in accordance with certain embodiments.

As shown in FIG. 7, when the question asks what the capital of Palapala is, since the system has injected the capital of Palapala via the external knowledge injector in advance as A-city, the original LLM answer of Asunción (shown via reference numeral 702) is overwritten, then the new answer is A-city (as shown via reference numeral 704).

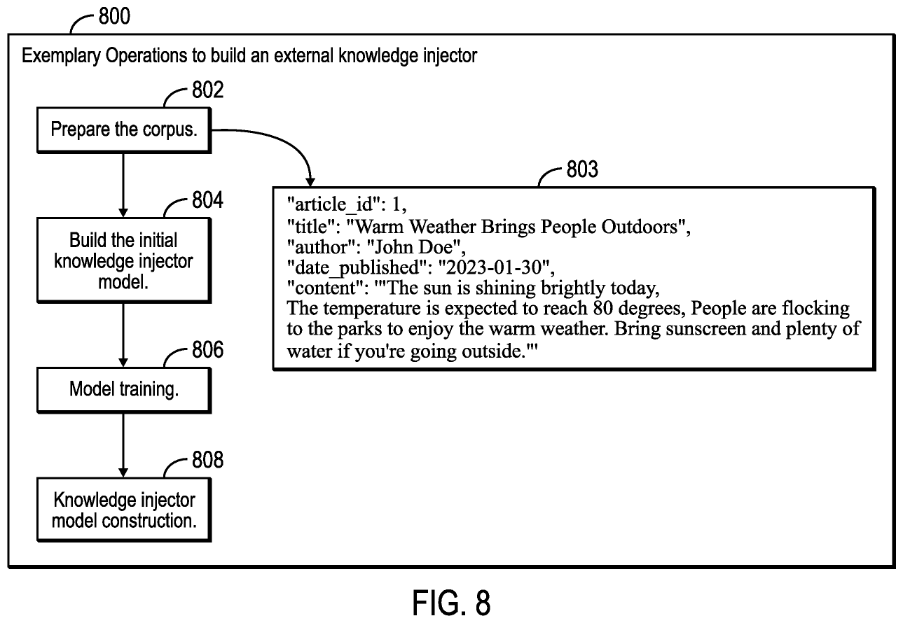

FIG. 8 illustrates a block diagram 800 that shows operations to build an external knowledge injector, in accordance with certain embodiments.

The operations to build an external knowledge injector (i.e., the external model) are as follows:

1. Prepare the corpus (reference numeral 802): The corpus is composed of a mixture of part of open source data and/or real-time knowledge ready to be injected (e.g., with a ratio of 6:4), and the data format is consistent with the pre-training data of the LLM model that needs to be enhanced. In certain embodiments, the LLM may be a GPT-3 as an example, and the data format is as shown via reference numeral 803.
2. Build the initial knowledge injector model (reference numeral 804): The knowledge injector model should be consistent with the LLM that needs to be enhanced. In some embodiments, the model size of the initial knowledge injector model is required to be small. The initial knowledge injector model itself is a machine learning model.
3. Model training (reference numeral 806): There is no need to build a pre-trained language model from scratch, which can make it easier to update real-time knowledge. In certain embodiments the corpus built in block 802 is used to fine-tune the open source GPT-3 mini. The criterion for fine-tuning success is that mini has fully memorized the real-time knowledge in the corpus. This model training refers to training the initial knowledge injector model.
4. Knowledge injector model construction (reference numeral 808): In this phase, the process removes the embedding layer and the output layer of the initial knowledge injector model, and finally forms the knowledge injector network model. The embedding layer and the output layer are deleted because in certain embodiments, the knowledge injector model does not receive natural language tokens, nor does it output in the form of natural language tokens. Its input and output exist in the form of embeddings.

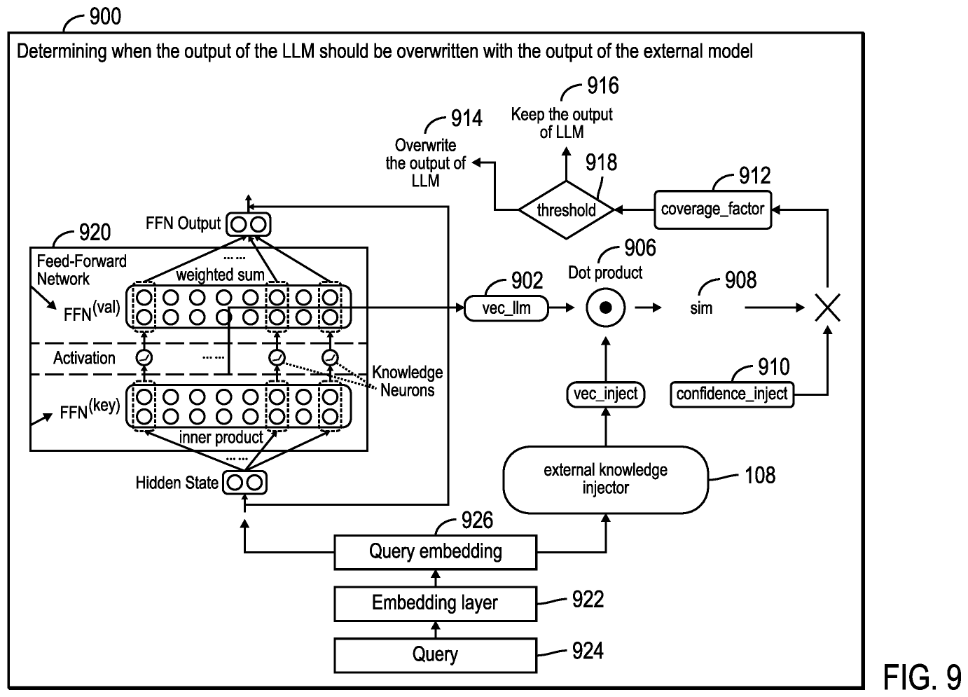

FIG. 9 illustrates a block diagram 900 that shows operations for determining when the output of an LLM should be overwritten with the knowledge injector model in accordance with certain embodiments.

Certain embodiments obtain a knowledge injector model that stores real-time knowledge, which can overwrite the output of LLM when appropriate. Certain embodiments choose when the knowledge injector is to cover the output of LLM.

Certain embodiments input the question into the original LLM and the knowledge injector model at the same time, and intercept the Value vector generated by the FFN layer in the LLM model and the output vector generated by the knowledge injector model, which are recorded as vec_llm 902 and vec_inject 904 respectively.

Certain embodiments perform the Dot product operation 906 on vec_llm 902 and vec_inject 904. The output is a 0-1 number, which is recorded as sim 908. The closer to 0, the less similar vec_llm and vec_inject are to each other, and the closer to 1, the more similar vec_llm and vec_inject are to each other. Then for certain embodiments the process obtains the confidence degree confidence_inject 910 when generating vec_inject 904. This confidence_inject 910 is produced via the external knowledge injector model as an accompanying output that accompanies the vec_inject 904 and indicates the degree of confidence (e.g., in a statistical percentage) that the external knowledge injector model has that its determined answer (vec-inject 904) is the correct answer to the query. The confidence degree may be determined in certain embodiments via mechanisms such as use of delta method, Bayesian method, mean variance estimation, softmax, bootstrap, logistic regression probabilities, etc. The machine learning model used for the external knowledge injector model needs to have capabilities that enable the estimation of the confidence degree.

Certain embodiments perform operations to multiply confidence_inject 910 with sim 908 to produce a coefficient for judging whether it is necessary to select the answer from the external knowledge injector model to replace the output of LLM, denoted as coverage_factor 912. The larger the coverage_factor 912, the more the answers of the original LLM need to be covered or replaced by the knowledge injector model. This is because the knowledge injector model is only sensitive to real-time knowledge injected in advance, so when answering questions that are irrelevant to real-time knowledge, the knowledge injector will tend to generate an answer vector that is highly random and irrelevant to the question (while the confidence of this answer will also be relatively low), which also makes the coverage_factor coefficient relatively small. However, when answering questions that are highly related to real-time knowledge, since the knowledge injector is sensitive to the real-time knowledge injected in advance, it will generate an answer vector that is very relevant to the question (at the same time, the confidence of this answer will be relatively high) [as shown via reference numerals 914, 916, 918]. The coverage_factor 912 is compared to a threshold value 918 in some embodiments and must exceed the threshold value to be passed to the overwrite 914 stage. Otherwise, the proceeds along to 916 to keep the output of the LLM.

In certain embodiments, the dot product calculations 906, the threshold comparison 918, and associated operations shown in FIG. 9 may be performed by additional code associated with the external knowledge injector where the additional code is maintained outside the external knowledge injector. In alternative embodiments, the additional code may reside within the external knowledge injector.

In a simplified embodiment, the confidence determination includes an internal degree of confidence that the external machine learning model produces for accuracy of the response. This internal degree of confidence itself is compared to a predetermined threshold value to determine whether the injector produced value overwrites the LLM answer. For example, if the internal degree of confidence of the external injector model for its answer to a first query exceeds 80% confidence then the external injector model will overwrite the answer (at the appropriate vector position) of the LLM with its own answer. This embodiment does not require the dot product multiplication against the answer vector from the LLM.

In certain embodiments shown in FIG. 9, the external knowledge injector is shown via reference numeral 108, and the FFN of the LLM 106 of FIG. 1 is shown via reference numeral 920. In certain embodiments, the external knowledge injector 108 and the LLM 106 (of FIG. 1) having the FFN 920 share a first embedding layer 922. When the query 924 enters the first embedding layer 922, a query embedding 926 is generated. Then this query embedding 926 enters the FFN 920 and the external knowledge injector 108 to complete subsequent operations via the FFN 920 and the external knowledge injector 108.

In certain embodiments, operations are performed to produce, via a first language machine learning model (LLM), a first embedding that represents the question. The first embedding is transmitted from the first language machine learning model to the external machine learning model, wherein the external machine learning model generates the response and the confidence determination based on an analysis of the first embedding.

The generative language model follows the “chain of thought” (CoT) mode when reasoning in at least some embodiments. In the CoT mode, it decomposes a multi-step reasoning problem into multiple intermediate steps and makes the LLM more interpretable. The answers generated by the model may be similar to the solutions to the questions in a mathematics test. First, the thinking process may be generated, and then the answer may be finally obtained. When outputting coverage, the embodiments do not need to cover all output semantic fragments, but only need to cover the final answer. However, certain embodiments cannot monitor the generation process of the model, and the final answer may be in the middle of the output, or it may be at the end of the output. In order to determine which output is the final answer and needs to be covered, certain embodiments adopt an idea similar to the pointer network, and use the vec_inject generated by the knowledge injector model to perform point multiplication with the vector of the text token generated at each step of the generative language model, and then amplify the result of the dot product through the RELU function, and finally determine the token segment that needs to be replaced in the token sequence. In certain embodiments, a multi-layer perceptron that is a feed-forward layer may be used.

Embodiments may not need to completely modify the sequence generated by LLM, but only need to modify the wrong entities or text fragments. During the process of determining which text fragment needs to be modified, certain embodiments use a pointer neural network to determine the two numbers start and end. These two numbers represent the text fragment starting from start and ending at end that needs to be modified.

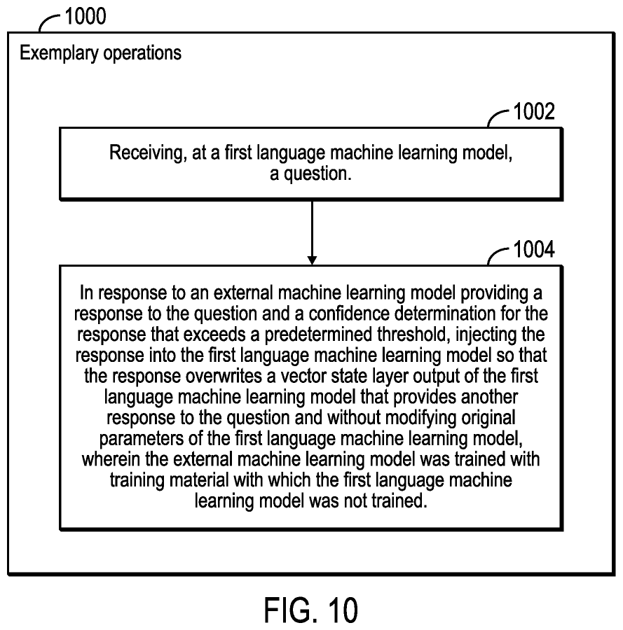

FIG. 10 illustrates certain exemplary operations 1000 to augment an LLM with an external model, in accordance with certain embodiments.

Control starts at block 1002 in which a question is received at a first language machine learning model. From block 1002 control proceeds to block 1004, in which in response to an external machine learning model providing a response to the question and a confidence determination for the response that exceeds a predetermined threshold, the response is injected into the first language machine learning model so that the response overwrites a vector state layer output of the first language machine learning model that provides another response to the question and without modifying original parameters of the first language machine learning model, where the external machine learning model was trained with training material with which the first language machine learning model was not trained.

In certain embodiments, the response of the external machine learning model is injected between a first layer and a second layer of a feed-forward network (FFN) of the first language machine learning model.

In certain additional embodiments, the first layer is a key layer, and wherein the second layer is a value layer.

In further embodiments, the external machine learning model is smaller in size than the first language machine learning model.

In yet further embodiments, the operations further comprise: preparing a corpus;

building an initial external machine learning model; training the initial external machine learning model with the corpus; and building the external machine learning model from the initial external machine learning model, wherein inputs and outputs of the external machine learning model are embeddings.

In certain embodiments, the building of the external machine learning model comprises removing an embedding layer and an output layer of the initial external machine learning model such that the external machine learning model does not receive language tokens and does not output natural language tokens.

In further embodiments, the external machine learning model produces the confidence determination via: obtaining a first value vector from the first language machine learning model, the first value vector comprising the another response to the question; performing a dot product operation of the first value vector and a first external value vector that represents the response of the external machine learning model such that a dot product value is produced; and multiplying the dot product value against an internal degree of confidence that the external machine learning model produces for accuracy of the response.

In yet further embodiments, the confidence determination comprises an internal degree of confidence that the external machine learning model produces for accuracy of the response.

In certain embodiments, the training material used to train the external machine learning model is new material that was unavailable at a time of training the first language machine learning model.

In further embodiments, operations performed further comprise: producing, via the first language machine learning model, a first embedding that represents the question; transmitting the first embedding from the first language machine learning model to the external machine learning model; and wherein the external machine learning model generates the response and the confidence determination based on an analysis of the first embedding.

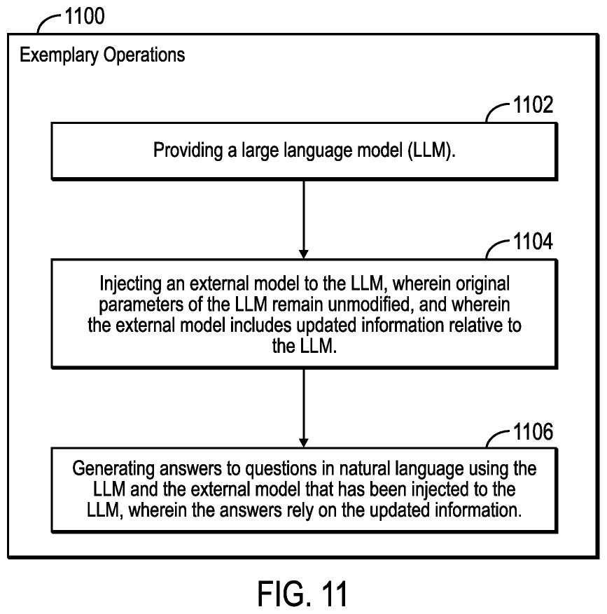

FIG. 11 illustrates exemplary operations 1100, in accordance with certain embodiments.

Control starts at block 1102 in which a large language model (LLM) is provided. An external model is injected to the LLM, where original parameters of the LLM remain unmodified, and where the external model includes updated information relative to the LLM (at block 1104). Answers to questions are generated (at block 1106) in natural language using the LLM and the external model that has been injected to the LLM, where the answers rely on the updated information.

Therefore, FIGS. 1-11 illustrate certain embodiments for augmenting an LLM with an external model to avoid retraining or fine-tuning of the LLM.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

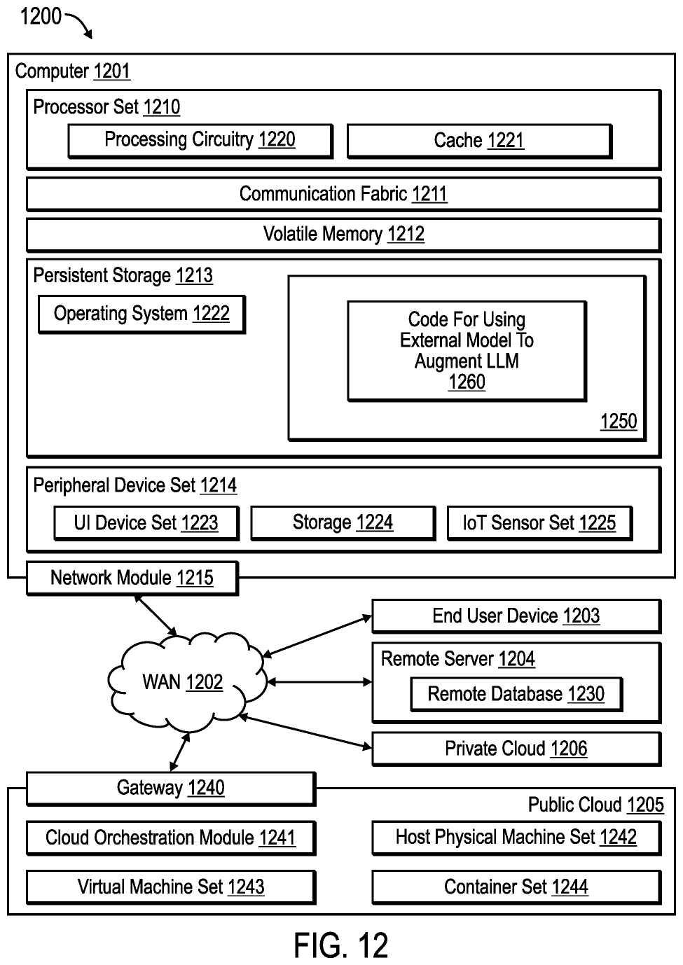

In FIG. 12, computing environment 1200 contains an example of an environment for the execution of at least some of the computer code (block 1250) involved in using external model to augment LLM that may perform operations shown in FIGS. 1-11.

In addition to block 1250, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1250, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible computer 1201 may be located in a cloud, even though it is not shown in a cloud in FIG. 8. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1250 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open-source Portable Operating System Interface-type operating systems that employ a kernel. The code included in block 1250 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. I/O T sensor set 1225 is made up of sensors that can be used in Internet of Things applications. For example, one sensor may be a thermometer and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

CLOUD COMPUTING SERVICES AND/OR MICROSERVICES (not separately shown in FIG. 12): private and public clouds 1205, 1206 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method comprising:
receiving, at a first language machine learning model, a question; and
in response to an external machine learning model providing a response to the question and a confidence determination for the response that exceeds a predetermined threshold, injecting the response into the first language machine learning model so that the response overwrites a vector state layer output of the first language machine learning model that provides another response to the question and without modifying original parameters of the first language machine learning model, wherein the external machine learning model was trained with training material with which the first language machine learning model was not trained.

2. The computer-implemented method of claim 1, wherein the response of the external machine learning model is injected between a first layer and a second layer of a feed-forward network (FFN) of the first language machine learning model.

3. The computer-implemented method of claim 2, wherein the first layer is a key layer, and wherein the second layer is a value layer.

4. The computer-implemented method of claim 1, wherein the external machine learning model is smaller in size than the first language machine learning model.

5. The computer-implemented method of claim 1, the computer-implemented method further comprising:
preparing a corpus;
building an initial external machine learning model;
training the initial external machine learning model with the corpus; and
building the external machine learning model from the initial external machine learning model, wherein inputs and outputs of the external machine learning model are embeddings.

6. The computer-implemented method of claim 5, wherein the building of the external machine learning model comprises removing an embedding layer and an output layer of the initial external machine learning model such that the external machine learning model does not receive language tokens and does not output natural language tokens.

7. The computer-implemented method of claim 1, wherein the external machine learning model produces the confidence determination via:
obtaining a first value vector from the first language machine learning model, the first value vector comprising the another response to the question;
performing a dot product operation of the first value vector and a first external value vector that represents the response of the external machine learning model such that a dot product value is produced; and
multiplying the dot product value against an internal degree of confidence that the external machine learning model produces for accuracy of the response.

8. The computer-implemented method of claim 1, wherein the confidence determination comprises an internal degree of confidence that the external machine learning model produces for accuracy of the response.

9. The computer-implemented method of claim 1, wherein the training material used to train the external machine learning model is new material that was unavailable at a time of training the first language machine learning model.

10. The computer-implemented method of claim 1, further comprising:
producing, via the first language machine learning model, a first embedding that represents the question; and
transmitting the first embedding from the first language machine learning model to the external machine learning model, wherein the external machine learning model generates the response and the confidence determination based on an analysis of the first embedding.

11. A computer system comprising:
a processor set;
a set of one or more computer-readable storage media; and
program instructions, collectively stored in the set of the one or more storage media, for causing the processor set to perform computer operations comprising:
receiving, at a first language machine learning model, a question; and
in response to an external machine learning model providing a response to the question and a confidence determination for the response that exceeds a predetermined threshold, injecting the response into the first language machine learning model so that the response overwrites a vector state layer output of the first language machine learning model that provides another response to the question and without modifying original parameters of the first language machine learning model, wherein the external machine learning model was trained with training material with which the first language machine learning model was not trained.

12. The computer system of claim 11, wherein the external machine learning model produces the confidence determination via:
obtaining a first value vector from the first language machine learning model, the first value vector comprising the another response to the question;
performing a dot product operation of the first value vector and a first external value vector that represents the response of the external machine learning model such that a dot product value is produced; and
multiplying the dot product value against an internal degree of confidence that the external machine learning model produces for accuracy of the response.

13. The computer system of claim 11, wherein the confidence determination comprises an internal degree of confidence that the external machine learning model produces for accuracy of the response.

14. The computer system of claim 11, wherein the training material used to train the external machine learning model is new material that was unavailable at a time of training the first language machine learning model.

15. The computer system of claim 11, the computer operations further comprising:
producing, via the first language machine learning model, a first embedding that represents the question; and
transmitting the first embedding from the first language machine learning model to the external machine learning model, wherein the external machine learning model generates the response and the confidence determination based on an analysis of the first embedding.

16. A computer program product comprising:
a set of one or more computer readable storage media; and
program instructions, collectively stored in the set of one or more storage media, for causing a processor set to perform computer operations comprising:
receiving, at a first language machine learning model, a question; and
in response to an external machine learning model providing a response to the question and a confidence determination for the response that exceeds a predetermined threshold, injecting the response into the first language machine learning model so that the response overwrites a vector state layer output of the first language machine learning model that provides another response to the question and without modifying original parameters of the first language machine learning model, wherein the external machine learning model was trained with training material with which the first language machine learning model was not trained.

17. The computer program product of claim 16, wherein the external machine learning model produces the confidence determination via:
obtaining a first value vector from the first language machine learning model, the first value vector comprising the another response to the question;
performing a dot product operation of the first value vector and a first external value vector that represents the response of the external machine learning model such that a dot product value is produced; and
multiplying the dot product value against an internal degree of confidence that the external machine learning model produces for accuracy of the response.

18. The computer program product of claim 16, wherein the confidence determination comprises an internal degree of confidence that the external machine learning model produces for accuracy of the response.

19. The computer program product of claim 16, wherein the training material used to train the external machine learning model is new material that was unavailable at a time of training the first language machine learning model.

20. The computer program product of claim 16, the operations further comprising:
producing, via the first language machine learning model, a first embedding that represents the question; and
transmitting the first embedding from the first language machine learning model to the external machine learning model, wherein the external machine learning model generates the response and the confidence determination based on an analysis of the first embedding.
